(19) United States
(12) Patent Application Publication
(10) Pub. No.: US 2014/0101925 A1
(43) Pub. Date: Apr. 17, 2014

(54) POLISHING HEAD, POLISHING APPARATUS, AND METHOD FOR POLISHING WORKPIECE

(71) Applicant: Hisashi Masumura, Nishishirakawa (JP)

(72) Inventor: Hisashi Masumura, Nishishirakawa (JP)

(73) Assignee: SHIN-ETSU HANDOTAI CO., LTD., Tokyo (JP)

(21) Appl. No.: 14/117,566

(22) PCT Filed: May 28, 2012
(86) PCT No.: PCT/JP2012/003454

§ 371 Date: Nov. 13, 2013

(30) Foreign Application Priority Data
Jun. 21, 2011 (JP) 2011-137789

(51) Int. Cl. B23Q 3/10

(52) U.S. Cl. CPC B23Q 3/107
USPC 29/559; 269/22

(57) ABSTRACT

A polishing head configured to hold a workpiece at the time of polishing the workpiece by bringing a front surface of the workpiece into sliding contact with a polishing pad attached to on a turn table, the polishing head includes: a workpiece-holding board configured to hold a back surface of the workpiece, the workpiece-holding board being flexible and being composed of ceramics; a sealed space defined on a surface of the workpiece-holding board on an opposite side of a surface on which the workpiece is held; and a pressure-controlling device configured to control a pressure in the sealed space, the polishing head being capable of adjusting a shape of the flexible workpiece-holding board into a convex shape or a concave shape by controlling a pressure in the sealed space by the pressure-controlling device.

### TECHNICAL FIELD

The present invention relates to a polishing head, a polishing apparatus including the polishing head, and a method for polishing a workpiece, particularly to a polishing head, a polishing apparatus, and a method for polishing a workpiece that are preferable for obtaining a highly flat workpiece in polishing of a workpiece on the basis of a waxless mount system.

### BACKGROUND ART

In recent years, higher integration of semiconductor devices place demand for higher flatness of semiconductor wafers used in such devices. The higher flatness up to near the edge of wafers is also needed to raise the yield of semiconductor chips.

The shape of finished semiconductor wafers depends on a final mirror polishing process. For a 300-mm-diameter silicon wafer, in particular, primary polishing by double-side polishing is performed to meet strict specifications of the flatness, and then secondary polishing and finish polishing by single-side polishing is performed to remove scratches on the surface or to improve surface roughness.

The secondary and finish polishing by single-side polishing is needed to maintain or improve flatness obtained by the primary polishing by double-side polishing and to finish the front surface of a wafer into a perfect mirror-surface with no defects, such as scratches.

As shown in FIG. 10, a common single-side polishing apparatus includes a turn table 103 on which a polishing pad 102 is attached, a polishing-agent-supply mechanism 104, a polishing head 101, for example. Such a polishing apparatus 110 holds a workpiece W with the polishing head 101, supplies a polishing agent 105 from the polishing-agent-supply mechanism 104 onto the polishing pad 102, rotates both the turn table 103 and the polishing head 101, and polishes the workpiece W by bringing a front surface of the workpiece into sliding contact with the polishing pad 102.

Examples of a method of holding a workpiece with a polishing head include attaching the workpiece to a flat workpiece-holding board through an adhesive such as wax, and using a polishing head 121 of a waxless type, shown in FIG. 11, that holds a workpiece W with a workpiece-holding board 112 through a commercially available template assembly 113 having a template 113b, for preventing the workpiece from coming off, bonded to an elastic film 113a called a backing film.

Examples of the polishing head of a waxless type also include a polishing head 131, shown in FIG. 12, that includes a backing film 113a attached on a workpiece-holding board 112, instead of the commercially available template, and an annular guide ring 113b, for preventing a workpiece from coming off, provided around the side surface of the workpiece-holding board.

Unfortunately, the polishing heads 121 and 131 of a waxless type, as shown in FIGS. 11 and 12, polishes a workpiece into a workpiece having lower flatness, because the soft backing film 113a deforms at its outer peripheral portion to lower the polishing amount at the portion, and the workpiece is thereby polished into a concave shape due to rise at the outer peripheral portion (See Patent Document 1). In regard to this program, for example, Patent Document 1 suggests a method for suppressing the rise at the outer peripheral portion of a workpiece by inserting a spacer ring into the outer peripheral portion on the back surface of the workpiece to rise pressure at the portion of the workpiece.

### CITATION LIST

### Patent Literature

Patent Document 1: Japanese Unexamined Patent Application Publication No. 2007-274012
Patent Document 2: Japanese Unexamined Patent Application Publication No. H11-216661

### SUMMARY OF INVENTION

### Technical Problem

The rise at the outer peripheral portion occurs only in the early stage of the lifetime of the backing film 113a, and sag at the outer peripheral portion more often occurs in the polished wafer as the backing film is used for a longer time. There is accordingly a need for exchanging the spacer ring for one having a different thickness in accordance with the lifetime or detaching the spacer ring itself. This lowers operability. Also, the adjustment of the thickness of the spacer ring is so difficult that stable machining precision cannot be kept.

The polishing head of a waxless type reduces influence of unevenness of the back surface of the workpiece by a soft backing film 113a and keeps uniform polishing pressure against the front surface of the workpiece for uniform polishing. This type of the polishing head therefore cannot improve the flatness of a workpiece having a convex shape or a concave shape by polishing.

In regard to these problems, for example, Patent Document 2 suggests a method for polishing a workpiece having a convex shape into a flat workpiece by inserting a spacer into a central portion of a workpiece-holding board before attaching a backing film to form a workpiece-holding surface into a convex shape so that a polishing amount at the central portion of the workpiece increases.

This method, however, needs to exchange the spacer inserted between the workpiece-holding board and the backing film in accordance with the shape of the workpiece, resulting in poor operability. Also the adjustment of the thickness of the spacer is so difficult that the workpiece cannot be polished into a flat workpiece stably.

In view of the above-described problem, it is an object of the present invention to provide a polishing head of a waxless type, a polishing apparatus, and a method for polishing a workpiece that prevent rise of an outer peripheral portion of the workpiece, which is expected in the early stage of the lifetime of a backing film, and that enable a workpiece to be polished into a highly flat workpiece, regardless of a workpiece shape before polishing.

### Solution to Problem

To achieve the object, the present invention provides a polishing head configured to hold a workpiece at the time of polishing the workpiece by bringing a front surface of the workpiece into sliding contact with a polishing pad attached on a turn table, the polishing head comprising: a workpiece-holding board configured to hold a back surface of the workpiece, the workpiece-holding board being flexible and being composed of ceramics; a sealed space defined on a surface of the workpiece-holding board on an opposite side of a surface on which the workpiece is held; and a pressure-controlling means configured to control a pressure in the sealed space, the polishing head being capable of adjusting a shape of the flexible workpiece-holding board into a convex shape or a concave shape by controlling the pressure in the sealed space by the pressure-controlling means.

Such a polishing head, configured to hold a workpiece to be polished by flexible ceramics, can adjust the shape of the workpiece-holding board into a convex shape or a concave shape in accordance with the shape of the workpiece or usage of a backing film, and thereby suppress rise of the outer peripheral portion of the workpiece in the early stage of the lifetime of a backing film, enabling the workpiece to be polished into a highly flat workpiece, regardless of a workpiece shape before polishing.

The workpiece-holding board is preferably flexible to such an extent that a ratio of an outer diameter of the workpiece-holding board to a maximum variation of the adjustment into the convex shape or the concave shape (the maximum variation/the outer diameter) is 0.028×10⁻³ to 0.222×10⁻³.

Such a polishing head can more surely suppress the rise of the outer peripheral portion in the early stage of the lifetime of the backing film and polish the workpiece into a highly flat workpiece, regardless of a workpiece shape before polishing.

Moreover, the inner diameter of the sealed space is preferably larger than the outer diameter of the workpiece.

Such a polishing head can polish the workpiece into a workpiece whose entire surface is highly flat, particularly suppressing the rise of the outer peripheral portion of the workpiece more surely.

Moreover, the pressure-controlling means is preferably capable of controlling one or both of pressurization and depressurization of the sealed space.

Such a polishing head with the pressure-controlling means capable of pressurization of the sealed space can adjust a pre-formed concave shape of the workpiece-holding board into a convex shape by pressurization of the sealed space, thus enabling the shape of the workpiece-holding board to be adjusted into either a concave shape or a convex shape when the workpiece is polished. The polishing head with the pressure-controlling means capable of depressurization of the sealed space can adjust a pre-formed convex shape of the workpiece-holding board into a concave shape by depressurization of the sealed space. The polishing head with the pressure-controlling means capable of both of pressurization and depressurization can optionally adjust a pre-formed flat shape of the workpiece-holding board into either a concave shape or a convex shape by depressurization or pressurization of the sealed space, respectively.

Moreover, the workpiece-holding board is preferably composed of alumina ceramics or silicon carbide ceramics.

Such a workpiece-holding board, which has a small thermal expansion coefficient, can suppress thermal deformation of the workpiece-holding board during polishing, thereby enabling polishing into a highly flat workpiece.

Furthermore, the present invention provides a polishing apparatus for polishing a front surface of a workpiece, the polishing apparatus comprising: a polishing pad attached on a turn table; a polishing-agent-supply mechanism configured to supply a polishing agent onto the polishing pad; and a polishing head configured to hold the workpiece according to the present invention.

Such a polishing apparatus can adjust the shape of the workpiece-holding board into a convex shape or a concave shape in accordance with the shape of the workpiece or usage of a backing film, and thereby suppress both rise of the outer peripheral portion of the workpiece in the early stage of the lifetime of a backing film and sag of the outer peripheral portion of the workpiece in the latter stage of the lifetime, enabling the workpiece to be polished into a highly flat workpiece, regardless of a workpiece shape before polishing.

Furthermore, the present invention provides a method for polishing a workpiece by bringing a front surface of the workpiece into sliding contact with a polishing pad attached on a turn table, the method comprising: holding the workpiece with a polishing head according to the present invention; adjusting a shape of the flexible workpiece-holding board by controlling the pressure in the sealed space of the polishing head; and then polishing the workpiece.

Such a method can adjust the shape of the workpiece-holding board into a convex shape or a concave shape in accordance with the shape of the workpiece or usage of a backing film, and thereby suppress both rise of the outer peripheral portion of the workpiece in the early stage of the lifetime of a backing film and sag of the outer peripheral portion of the workpiece in the latter stage of the lifetime, enabling the workpiece to be polished into a highly flat workpiece, regardless of a workpiece shape before polishing.

### Advantageous Effects of Invention

The polishing head of the present invention includes a flexible workpiece-holding board composed of ceramics, and a sealed space defined on a surface of the workpiece-holding board on an opposite side of a surface on which the workpiece is held, thereby enabling the shape of the flexible workpiece-holding board to be adjusted into a convex shape or a concave shape through control of the pressure in the sealed space. The polishing head can therefore suppress rise of the outer peripheral portion of the workpiece by adjusting the shape of the workpiece-holing board into the concave shape in the early stage of the lifetime of a backing film, and polish the workpiece into a highly flat workpiece by opposed adjustment to the above, regardless of usage of the backing film, in the latter stage of the lifetime of the backing film. The polishing head also can polish the workpiece into a highly flat workpiece by adjusting the shape of the workpiece-holing board into the convex shape or the concave shape in accordance with the shape of the workpiece before polishing.

### BRIEF DESCRIPTION OF DRAWINGS

FIG. 1 is a schematic view showing an example of a polishing head and a polishing apparatus of the present invention;

FIG. 2 is a schematic view showing an example of a polishing head of the present invention including a sealed space defined by bonding a tubular member to a workpiece-holding board;

FIG. 3 shows an example of a polishing head of the present invention including a workpiece-holding board having one body defining the outer periphery of a sealed space;

FIG. 4 shows an example of a polishing head of the present invention including a pressurization controller and a depressurization controller;

FIG. 5 shows a measurement result of flatness of the workpiece-holding board in Example 1;

FIG. 6 shows results of Example 1 and Comparative Example 1;

FIG. 7 shows results of Example 2 and Comparative Example 2;

FIG. 8 shows results of Example 3 and Comparative Example 3;

FIG. 9 shows results of Example 4 and Comparative Example 4;

FIG. 10 is a schematic view showing an example of a conventional polishing head and a conventional polishing apparatus;

FIG. 11 is a schematic view showing an example of a conventional polishing head using a backing film; and

FIG. 12 is a schematic view showing another example of a conventional polishing head using a backing film.

### DESCRIPTION OF EMBODIMENTS

Although embodiment of the present invention will be described hereinafter, the present invention is not restricted thereto.

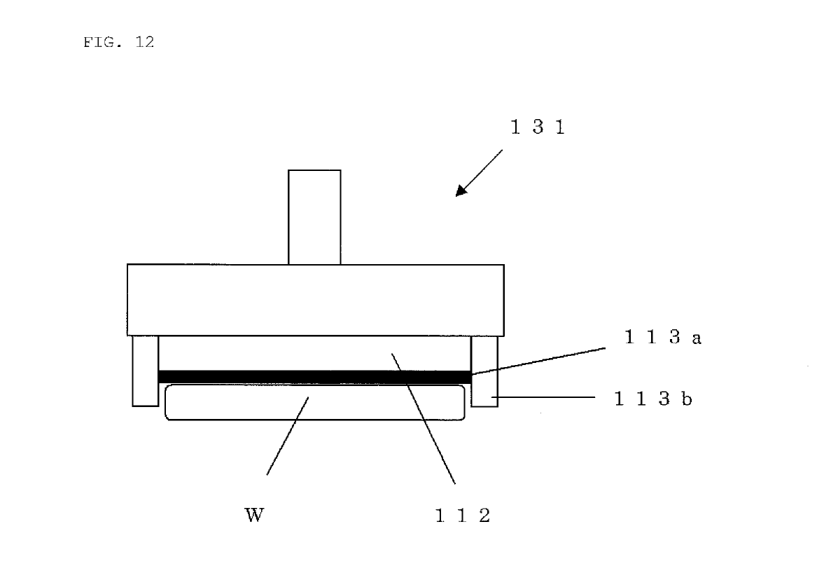

A conventional polishing head of a waxless type, as shown in FIGS. 11 and 12, disadvantageously polishes a workpiece into a workpiece having lower flatness, because a soft backing film is deformed at its outer peripheral portion to lower the polishing amount at the portion, and the workpiece is thereby polished into a concave shape due to rise at the outer peripheral portion.

Accordingly, the present inventor repeatedly conducted keen examination to solve such a problem. As a result, the present inventor found a means for adjusting a polishing pressure against the outer peripheral portion of a workpiece, more specifically a means including a flexible workpiece-holding board composed of thin ceramics, and a sealed space defined on a surface of the workpiece-holding board on an opposite side of a surface on which the workpiece is held. This means changes the shape of the workpiece-holding board into a concave shape though control of the pressure of the sealed space to adjust the polishing pressure. The present inventor also found that the pressure of the sealed space is controlled such that the workpiece-holding board changes its shape into a large concave shape in the early stage of the lifetime of the backing film, and the pressure of the sealed space is controlled such that the workpiece-holding board changes its shape into a smaller concave shape as the lifetime of the backing film becomes shorter, whereby the workpiece can be polished into a flat workpiece, regardless of the lifetime of the backing film, without exchanging a spacer ring, which is complicated operation conventionally performed. The present inventor brought the present invention to completion based on these findings.

The polishing head, the polishing apparatus, and the method for polishing a workpiece of the present invention will now be specifically described with reference to the accompanying drawings, but the present invention is not restricted thereto.

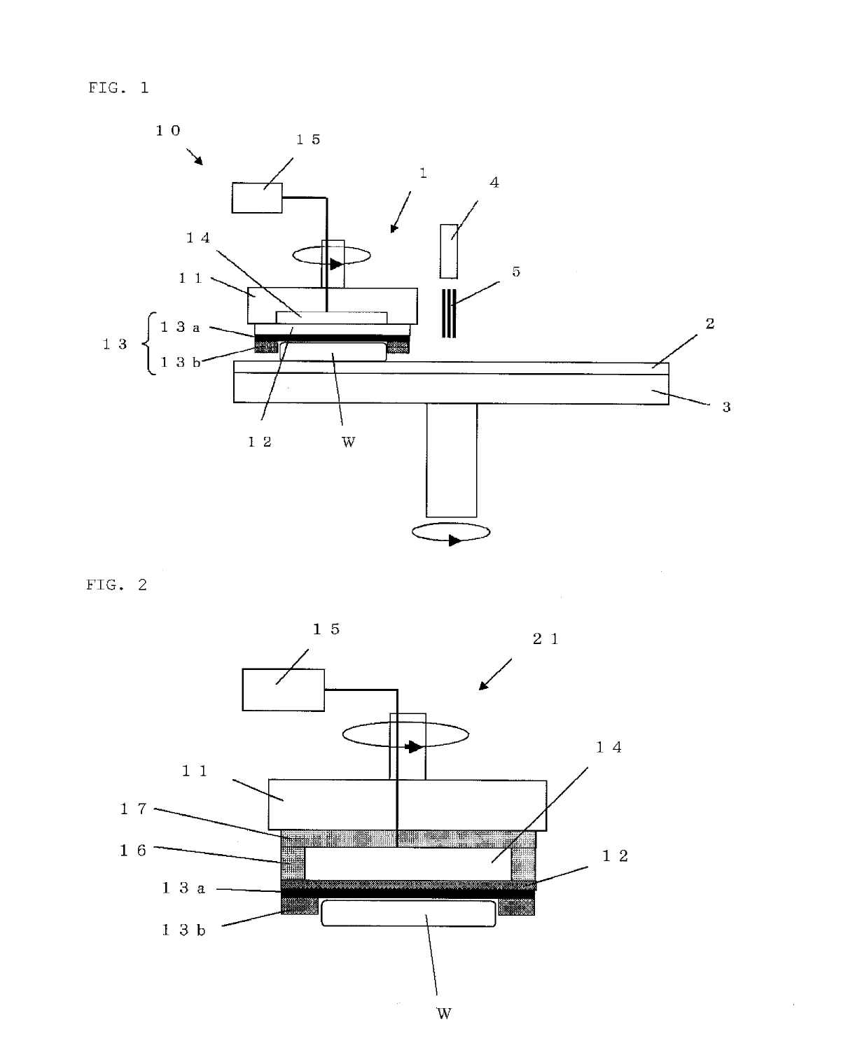

FIG. 1 is a schematic view showing an example of a polishing head and a polishing apparatus including the polishing head of the present invention.

The polishing head of the present invention will be first described. As shown in FIG. 1, the polishing head 1 includes polishing head body 11, a workpiece-holding board 12, configured to hold a back surface of a workpiece W, that is flexible and composed of ceramics, a sealed space 14 defined on a surface of the workpiece-holding board on an opposite side of a surface on which the workpiece W is held, and a pressure-controlling means 15 configured to control a pressure in the sealed space.

The workpiece W is held on a backing film 13a attached onto the workpiece-holding board 12. A template 13b is provided outside the workpiece W to prevent the workpiece W from coming off the polishing head 1 during polishing. Here, a commercially available template assembly 13 having a template 13b attached onto the backing film 13a can be used. Alternatively, an annular guide ring that prevents the workpiece from coming off may be provided outside the backing film 13a attached onto the workpiece-holding board 12, instead of the template 13a.

The sealed space 14, defined on the surface of the workpiece-holding board 12 on the opposite side of the surface on which the workpiece W is held, is coupled with a pressure controller 15. The pressure controller 15 can control a pressure in the sealed space 14.

The workpiece-holding board 12 is composed of ceramics and has flexibility. Here, the flexibility of the workpiece-holding board 12 can be obtained by reducing the thickness of the workpiece-holding board 12. The thickness of the workpiece-holding board 12 is not restricted in particular, and appropriately adjusted in accordance with a ceramic material to be used, an outer diameter of the workpiece-holding board 12, an inner diameter of the sealed space, and so on. The thickness is thus adjusted so as to allow the workpiece-holding board to change its shape into a convex shape or a concave shape to polish the workpiece into a flat workpiece.

In the present invention, the flexibility of the workpiece-holding board means that the workpiece-holding board is capable of changing its shape into a convex shape or a concave shape. The workpiece-holding board preferably change its shape within the following range:

The ratio of the outer diameter of the workpiece-holding board to a maximum variation of the adjustment into the convex shape or the concave shape (the maximum variation/the outer diameter) is preferably 0.028×10⁻³ to 0.222×10⁻³. This corresponds to a situation where the maximum variation is 10 μm to 80 μm for an outer diameter of 360 mm, for example.

It is to be noted that the convex shape of the workpiece-holding board means a shape protruding downward round the center of the workpiece-holding board, and the concave shape means a shape protruding upward round the center of the workpiece-holding board, when the workpiece-holding board is viewed in a side-surface direction.

The polishing head of the present invention, including a ceramics member, has rigidity required for polishing a workpiece with high precision and flexibility obtained by the adjustment of the thickness, i.e., the workpiece-holding board 12 can be change its shape. The shape of the workpiece-holding board 12 can be adjusted into the convex shape by increasing the pressure in the sealed space 14 to more than an atmospheric pressure by the pressure controller 15. The shape of the workpiece-holding board 12 can be adjusted into the concave shape by decreasing the pressure in the sealed space 14 to less than an atmospheric pressure.

A polishing agent of an alkali or acid solution is generally used for polishing a semiconductor substrate as a workpiece, thereby resulting in metal contamination of a workpiece-holding board composed of a metal material due to elution of metallic ions. Advantageously, the workplace-holding board composed of ceramics can avoid such metal contamination. The ceramics workpiece-holding board can be machined with high precision required for a highly flat workpiece after polishing.

The workpiece-holding board 12 is preferably composed of a material having a small thermal expansion coefficient, such as alumina ceramics and silicon carbide ceramics, to suppress thermal deformation of the workpiece-holding board 12 during polishing, Table 1 shows Young's moduli and thermal expansion coefficients of alumina ceramics, silicon carbide ceramics, and stainless steel (SUS304). The alumina and silicon carbide ceramics exhibit a thermal expansion coefficient extremely smaller than that of stainless steel.

Such a polishing head of the present invention enables the shape of the workpiece-holding board to be adjusted into a convex shape or a concave shape in accordance with the shape of the workpiece to be polished or usage of the backing film to polish the workpiece into a highly flat workpiece.

The polishing head thus suppress the rise of the outer peripheral portion of the workpiece in the early stage of the lifetime of the backing film by decreasing the pressure in the sealed space to less than an atmospheric pressure and hence adjusting the shape of the workpiece-holding board into a concave shape to increase the polishing amount at the outer peripheral portion of the workpiece, thereby ensuring a polished wafer with high flatness. Also, in polishing of a workpiece having a convex shape, i.e., a workpiece having sag at its outer peripheral portion, the workpiece can be polished into a flat workpiece by increasing the pressure in the sealed space to more than an atmospheric pressure and hence adjusting the shape of the workpiece-holding board into a convex shape to increase the polishing amount at the central portion of the workpiece. In polishing of a flat workpiece with a baking film having a lifetime enabling polishing the workpiece evenly, the workpiece-holding board may be adjusted to a flat shape.

The sealed space of the polishing head can be configured as follows:

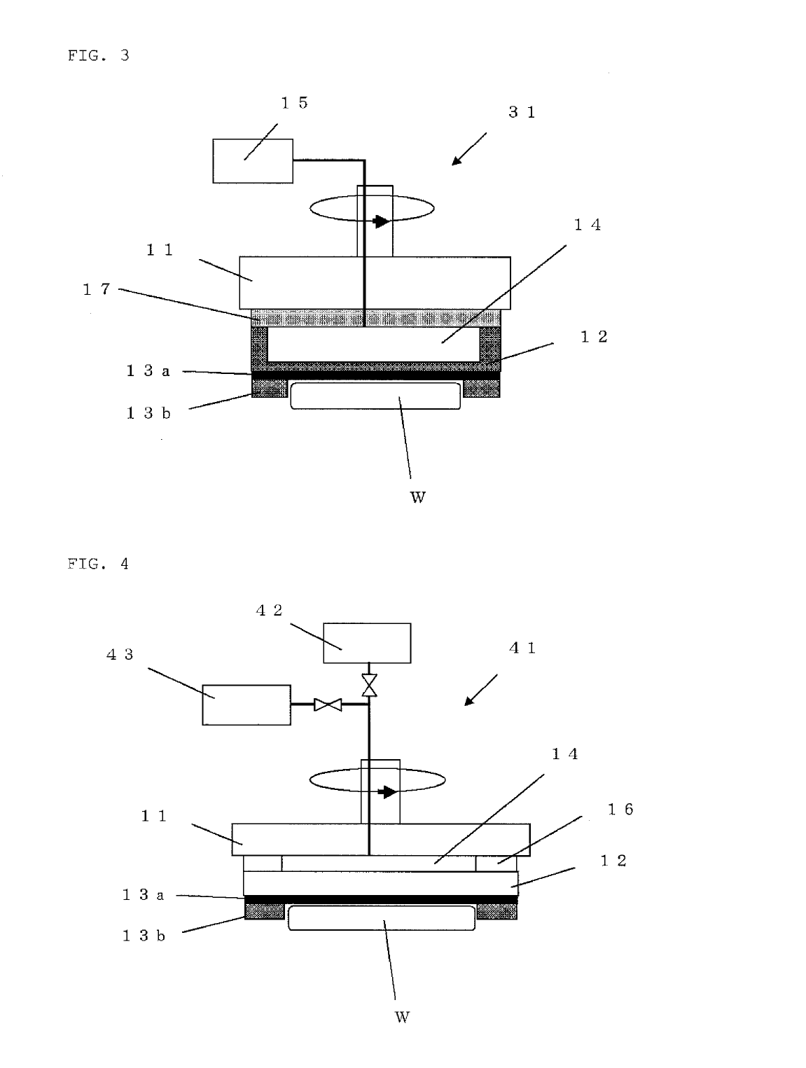

Like a polishing head 21 shown in FIG. 2, the sealed space 14 may be defined by bonding the workpiece-holding board 12 to the lower surface of a tubular member 16 having high rigidity, and providing a disk-shaped back plate 17 on the upper surface of the tubular member 16. Like a polishing head 31 shown in FIG. 3, alternatively, a workpiece-holding board having one body defining the outer periphery of the sealed space may be used, instead of bonding the workpiece-holding board 12 to the tubular member 16.

The polishing head having an inner diameter of the sealed space 14 larger than an outer diameter of the workpiece W can polish the workpiece into a workpiece whose entire surface is highly flat, particularly suppressing the rise of the outer peripheral portion of the workpiece more surely.

A plurality of sealed spaces may be provided on the surface of the workpiece-holding board on the opposite side of the surface on which the workpiece is held, and independent pressure controllers may be each coupled with these spaces to control the pressure in each of the sealed spaces so that the shape of the workpiece-holding board can be more accurately adjusted.

The pressure controlling means 15 may be configured to be capable of controlling one of pressurization and depressurization of the sealed space 14. For the polishing head having the pressure controlling means 15 capable of controlling only pressurization of the sealed space 14, the workpiece-holding board 12 may be adjusted into a concave shape in advance. In this case, controlling pressurization of the sealed space allows the workpiece-holding board to be adjusted from the concave shape into a convex shape. This polishing head can thus adjust the workpiece-holding board into either a concave shape or a convex shape when the workpiece is polished.

On the contrary, for the polishing head having the pressure controlling means 15 capable of controlling only depressurization of the sealed space 14, the workpiece-holding board 12 may be adjusted into a convex shape in advance. In this case, controlling depressurization of the sealed space allows the workpiece-holding board to be adjusted from the convex shape into a concave shape. This polishing head can similarly adjust the workpiece-holding board into either a concave shape or a convex shape when the workpiece is polished.

The pressure controlling means 14 can include both pressurization and depressurization controllers. The polishing head 41 shown in FIG. 4 includes the pressurization controller 42 and the depressurization controller 43 both coupled with the sealed space 14, controlling the pressurization and depressurization of the sealed space 14 by opening or closing a valve.

Such a polishing head can optionally adjust a flatly-adjusted workpiece-holding board into either a concave shape or a convex shape by depressurization or pressurization of the sealed space, regardless of the initial shape of the workpiece-holding board.

A polishing apparatus and a method for polishing a workpiece of the present invention will now be described.

As shown in FIG. 1, the polishing apparatus 10 has the turn table 3, the polishing pad 2 attached on the turn table 3, the polishing-agent-supply mechanism 4 configured to supply a polishing agent 5 onto the polishing pad 2, and the polishing head of the present invention configured to hold a workpiece W.

In the method for polishing a workpiece of the present invention, the workpiece W is held with the polishing head of such a polishing apparatus of the present invention. The shape of the flexible workpiece-holding board 12 is then adjusted by controlling the pressure in the sealed space 14 of the polishing head. At this time, the shape of the workpiece-holding board is adjusted into a convex shape or a concave shape in accordance with the shape of the workpiece to be polished or usage of the backing film, as described above for the polishing head. The workpiece is then polished by bringing the front surface of the workpiece into sliding contact with the polishing pad 2 attached on the turn table 3.

The polishing apparatus and the method for polishing a workpiece of the present invention thus enable a workpiece to be polished into a highly flat workpiece, regardless of the lifetime of the backing film and the shape of the workpiece before polishing.

### Example

Although the present invention will be more specifically described below with reference to examples of the present invention and comparative examples, the present invention is not restricted to these examples.

### Example 1

A polishing head, as shown in FIG. 4, was produced in the following manner, and the flatness of the workpiece-holding board was measured.

A workpiece-holding board 12 of alumina ceramics was evenly machined with an outer diameter of 360 mm and a thickness of 6 mm, and then bonded to the lower surface of a ceramics tubular member 16 with an outer diameter of 360 mm, an inner diameter of 320 mm, and a thickness of 20 mm by a commercially available epoxy resin adhesive. The upper surface of the tubular member 16 was fastened through bolts to define the sealed space 14. The pressurization controller 42 and the depressurization controller 43 were both coupled with the sealed space through a valve.

The produced polishing head was turned upside down and placed. The flatness of the workpiece-holding board 12 was measured while the pressure in the sealed space 14 was varied in the range of minus 50 to plus 50 kPa with respect to an atmospheric pressure by the pressurization controller 42 and the depressurization controller 43. For the flatness measurement of the workpiece-holding board, NANOMETRO 1000FR manufactured by Kuroda Precision Industries Ltd., was used.

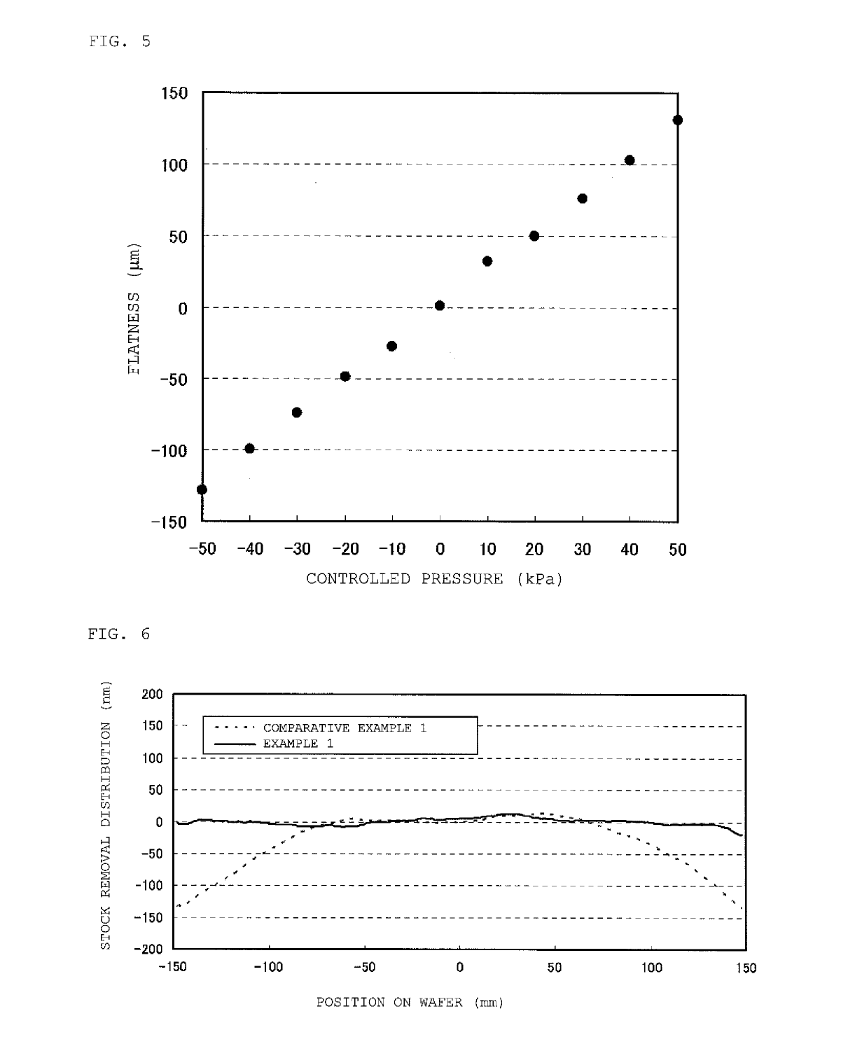

FIG. 5 shows a result of the measurement. The horizontal axis in FIG. 5 represents variation in pressure with respect to an atmospheric pressure, in which plus represents pressurization, whereas minus represents depressurization. The vertical axis in FIG. 5 represents the flatness of the workpiece-holding board for the variation in pressure, in which plus represents a convex shape, whereas minus represents a concave shape. It can be understood that, as shown in FIG. 5, the workpiece-holing board substantially linearly changed its shape with respect to the variation in pressure in the sealed space, and the shape of the workpiece-holding board can thus be adjusted into both a concave shape and a convex shape.

On the workpiece-holding board of the above polishing head was attached a commercially available template assembly having a template with an outer diameter of 355 m, an inner diameter of 302 mm, and a thickness of 575 μm attached on a backing film. This polishing head was provided in a polishing apparatus as shown in FIG. 1. The workpiece W, a silicon single crystal wafer with a diameter of 300 mm and a thickness of 775 μm, was polished. The silicon single crystal wafer used herein was subjected to primary double-side polishing, and an edge portion of the wafer was also polished, in advance. A 800-mm-diameter turn table, a normally used polishing pad, and a backing film in the early stage of its lifetime were used.

At the time of polishing, a polishing agent of an alkali solution containing colloidal silica was used, and the polishing head and the turn table were each rotated at 30 rpm. A polishing load (pressing force) for the workpiece W was set to 20 kPa in terms of contact pressure of the wafer by a non-illustrated pressurizing means. The depressurization controller controlled the pressure in the sealed space to a reduced pressure of 10 kPa with respect to an atmospheric pressure to adjust the shape of the workpiece-holding board into a concave shape of 27 μm, and the wafer was then polished. A polishing time was adjusted such that an average polishing stock removal of the wafer was 400 nm.

The variation in polishing stock removal in the plane of the polished wafer was evaluated. The polishing stock removal was calculated by measuring both the thicknesses of the wafer before and after polishing with a flatness measuring instrument in a region excluding a width 2 mm of the outermost peripheral portion as a flatness-guaranteed region and by obtaining differences between the thicknesses before and after polishing in a cross section of the wafer along a diametric direction. A flatness measuring instrument (WaferSight) manufactured by KLA-Tencor was used for measuring the flatness.

FIG. 6 shows a result of a distribution of the polishing stock removal of the wafer. FIG. 6 demonstrates that the variation in polishing stock removal was greatly suppressed in Example 1, more specifically the polishing stock removal of outer peripheral portion was approximately equivalent to that of the central portion, and a difference (a range) between a maximum value and a minimum value of the polishing stock removal in the diametric direction of the wafer was 32.5 nm. On the contrary, the variation in polishing stock removal in the later-described Comparative Example 1 was disadvantageously greater than that of Example 1, more specifically, a distribution of the polishing stock removal of the outer peripheral portion was smaller than that of the central portion, and the difference (the range) between a maximum value and a minimum value of the polishing stock removal of the wafer in the diametric direction was 148 nm.

Accordingly, the present invention enables the rise of the outer peripheral portion in the early stage of the lifetime of the backing film to be suppressed.

### Example 2

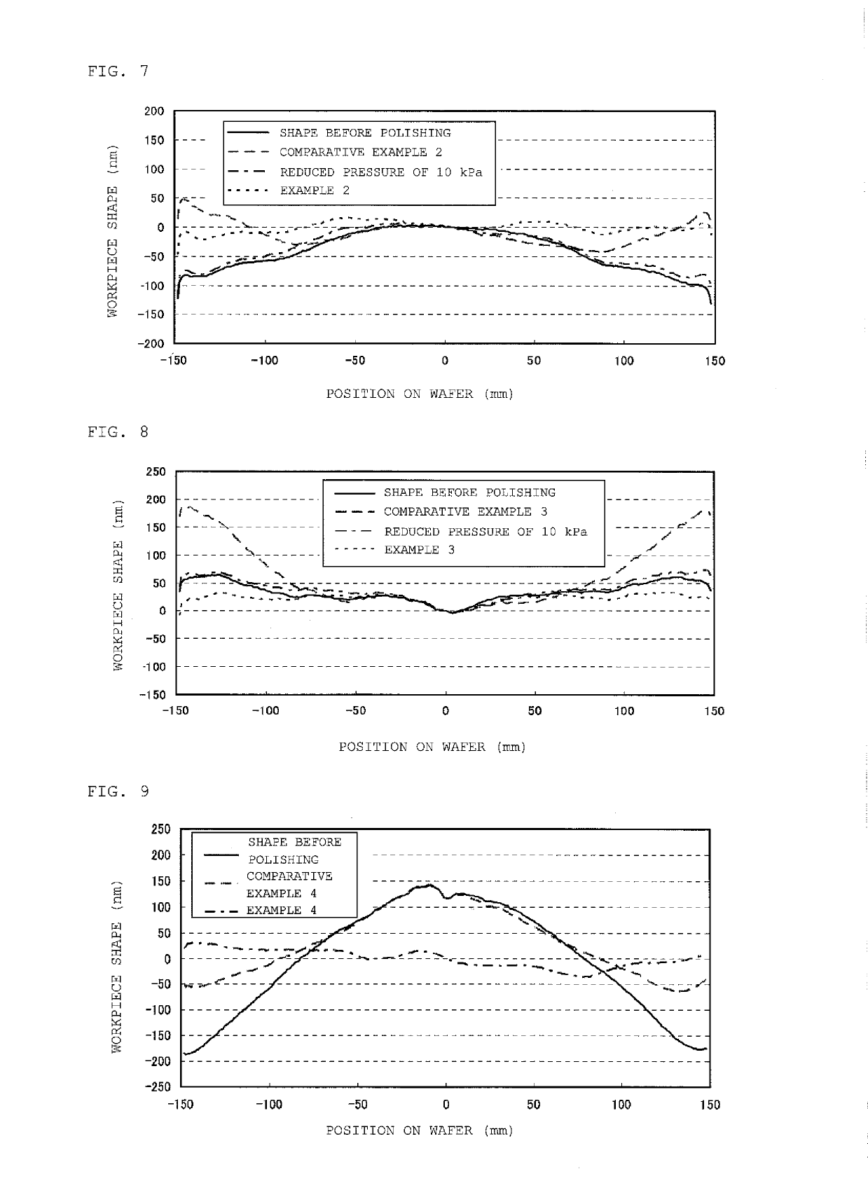

A silicon single crystal wafer was polished under the same polishing conditions as those in Example 1, except that the silicon single crystal wafer had a convex shape on a side to be polished before polishing and the pressure in the sealed space was set to an increased pressure of 5 kPa with respect to an atmospheric pressure to adjust the shape of the workpiece-holding board into a convex shape of 10 μm, and variation in shape of the wafer was evaluated. The convex shape of the silicon single crystal wafer described here corresponds to a sag shape of the outer peripheral portion. It is to be noted that the shape of the wafer before polishing shown in each of FIGS. 7 to 9 is a representative shape, and the wafer having substantially the same shape was used in each example.

FIG. 7 shows a result of the variation in shape of the wafer, and illustrates the shape of the wafer polished surface that is turned upward. FIG. 7 demonstrates that the difference (the range) between the maximum value and the minimum value of the thickness of the wafer in a diametric direction was greatly improved from 134.3 nm to 63.5 nm, and the wafer was polished into a flat shape, because the workpiece-holding board adjusted into a convex shape increased the polishing stock removal of the central portion of the wafer.

On the other hand, in the later-described Comparative Example 2, the difference (the range) between the maximum value and the minimum value of the thickness of the wafer in the diametric direction was improved from 134.3 nm to 91.6 nm due to the rise at the outer peripheral portion, which is caused in the early stage of the lifetime of the backing film. The convex shape of the central portion, however, did not change so much from the shape before polishing, and the improvement in the range was smaller than that in Example 2.

The conditions for adjusting the pressure in the sealed space in Example 2 were changed so as to adjust the shape of the workpiece-holding board into a concave shape of 27 μm by setting the pressure in the sealed shape to a decreased pressure of 10 kPa with respect to an atmospheric pressure. As a result, a substantially uniform polishing stock removal distribution was achieved, and hence the shape of the wafer before polishing was substantially maintained, more specifically, the difference (the range) between the maximum value and the minimum value of the thickness of the wafer in the diametric direction was in the range from 134.3 nm to 122.8 nm. This means the thickness before and after polishing is substantially equivalent.

Accordingly, the present invention enables a wafer to be polished into a highly flat wafer by adjusting the convex and concave shapes of the workpiece-holding board in accordance with the wafer shape before polishing.

### Example 3

A silicon single crystal wafer was polished under the same polishing conditions as those in Example 1, except that the silicon single crystal wafer had a slightly concave shape before polishing and the pressure in the sealed space was set to a reduced pressure of 15 kPa with respect to an atmospheric pressure to adjust the shape of the workpiece-holding board into a concave shape of 37 μm, and variation in shape of the wafer was evaluated.

FIG. 8 shows a result of the variation in shape of the wafer. FIG. 8 demonstrates that the difference (the range) between the maximum value and the minimum value of the thickness of the wafer in a diametric direction was improved from 67.7 nm to 42.2 nm, and the wafer was polished into a more flat shape, because the workpiece-holding board adjusted into a concave shape increased the polishing stock removal of the outer peripheral portion of the wafer.

On the other hand, in the later-described Comparative Example 3, the concave shape of the central portion did not change so much from the shape before polishing. The difference (the range) between the maximum value and the minimum value of the thickness of the wafer in the diametric direction was disadvantageously increased greatly from 67.7 nm to 191.6 nm due to the rise at the outer peripheral portion, which is caused in the early stage of the lifetime of the backing film.

The conditions for adjusting the pressure in the sealed space in Example 3 were changed so as to adjust the shape of the workpiece-holding board into a concave shape of 27 μm by setting the pressure in the sealed shape to a decreased pressure of 10 kPa with respect to an atmospheric pressure. As a result, a substantially uniform polishing stock removal distribution was achieved, and hence the shape of the wafer before polishing was substantially maintained, more specifically, the difference (the range) between the maximum value and the minimum value of the thickness of the wafer in the diametric direction was in the range from 67.7 nm to 77.2 nm. This means the thickness before and after polishing is substantially equivalent.

### Example 4

A silicon single crystal wafer was polished under the same polishing conditions as those in Example 1, except that the silicon single crystal wafer had a convex shape before polishing and the pressure in the sealed space was set to an increased pressure of 31.5 kPa with respect to an atmospheric pressure to adjust the shape of the workpiece-holding board into a convex shape of 80 μm, and variation in shape of the wafer was evaluated.

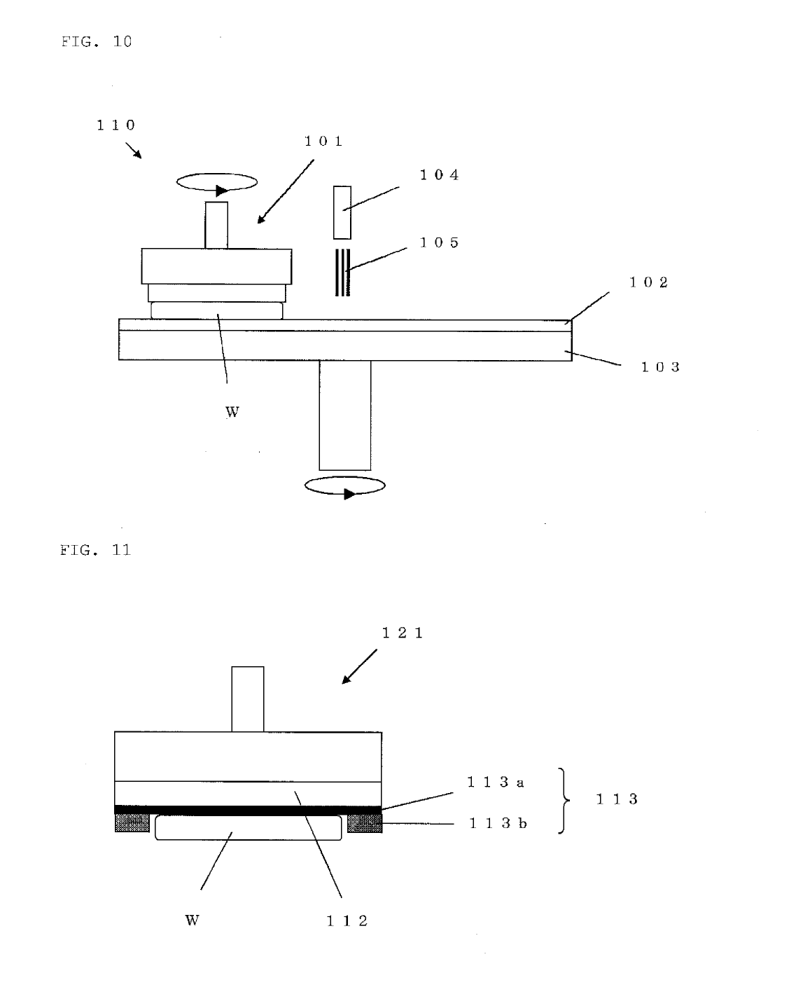

FIG. 9 shows a result of the variation in shape of the wafer. FIG. 9 demonstrates that the difference (the range) between the maximum value and the minimum value of the thickness of the wafer in the diametric direction was greatly improved from 329.9 nm to 66.6 nm, and the wafer was polished into a flat shape, because the workpiece-holding board adjusted into a convex shape increased the polishing stock removal of the central portion of the workpiece.

On the other hand, in the later-described Comparative Example 4, the difference (the range) between the maximum value and the minimum value of the thickness of the wafer in the diametric direction was improved from 329.9 nm to 205.8 nm due to the rise at the outer peripheral portion, which is caused in the early stage of the lifetime of the backing film. The convex shape of the central portion, however, did not change so much from the shape before polishing, and the improvement in the range was smaller than that in Example 4.

### Comparative Example 1

A silicon single crystal wafer was polished under the same conditions as those in Example 1 except for using a polishing head, as shown in FIG. 11, including a flat workpiece-holding board of alumina ceramic with an outer diameter of 360 mm, a thickness of 20 mm, a flatness of 0.8 μm, and no sealed space, unlike the present invention, and evaluation was carried out as with Example 1.

FIG. 6 shows a result. As shown in FIG. 6, the difference (the range) between the maximum value and the minimum value of the polishing stock removal of the wafer in the diametric direction was 148 nm, which was greater than 32.5 nm in Example 1. This means that the variation in polishing stock removal was disadvantageously greater than that in Example 1.

### Comparative Example 2

A silicon single crystal wafer was polished under the same conditions as those in Example 2 except for using a polishing head, as shown in FIG. 11, including a flat workpiece-holding board of alumina ceramic with an outer diameter of 360 mm, a thickness of 20 mm, a flatness of 0.8 μm, and no sealed space, unlike the present invention, and evaluation was carried out as with Example 2.

FIG. 7 shows a result. As shown in FIG. 7, the difference (the range) between the maximum value and the minimum value of the thicknes of the wafer in the diametric direction was 91.6 nm, which was disadvantageously greater than 63.5 nm in Example 2.

### Comparative Example 3

A silicon single crystal wafer was polished under the same conditions as those in Example 3 except for using a polishing head, as shown in FIG. 11, including a flat workpiece-holding board of alumina ceramic with an outer diameter of 360 mm, a thickness of 20 mm, a flatness of 0.8 μm, and no sealed space, unlike the present invention, and evaluation was carried out as with Example 3.

FIG. 8 shows a result. As shown in FIG. 8, the difference (the range) between the maximum value and the minimum value of the thickness of the wafer in the diametric direction was 191.6 nm, which was disadvantageously greater than 42.2 nm in Example 3.

### Comparative Example 4

A silicon single crystal wafer was polished under the same conditions as those in Example 4 except for using a polishing head, as shown in FIG. 11, including a flat workpiece-holding board of alumina ceramic with an outer diameter of 360 mm, a thickness of 20 mm, a flatness of 0.8 μm, and no sealed space, unlike the present invention, and evaluation was carried out as with Example 4.

FIG. 9 shows a result. As shown in FIG. 9, the difference (the range) between the maximum value and the minimum value of the thickness of the wafer in the diametric direction was 205.8 nm, which was disadvantageously greater than 66.6 nm in Example 4.

TABLE 1

| | | SILICON | |
|---|---|---|---|
| | ALUMINA | CARBIDE | STAINLESS |
| | CERAMICS | CERAMICS | SUS304 |
| YOUNG'S MODULUS GPa | 370 | 430 | 197 |
| THERMAL EXPANSION | 7.2 | 3.7 | 17.3 |
| COEFFICIENT ×10⁻⁶/° C. | | | |

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

For example, the polishing head of the present invention is not restricted to the conformations shown in FIGS. 1 to 4. For example, the shape of a main body of the polishing head can be appropriately designed except requirements described in claims. Moreover, a plurality of independent sealed spaces may be provided on the surface of the workpiece-holding board on an opposite side of a surface on which the workpiece is held so that the shape of the workpiece-holding board can be more accurately adjusted.

Additionally, the configuration of the polishing apparatus is not restricted to that shown in FIG. 1. For example, a polishing apparatus may be provided with a plurality of polishing heads of the present invention.

1-7. (canceled)

8. A polishing head configured to hold a workpiece at the time of polishing the workpiece by bringing a front surface of the workpiece into sliding contact with a polishing pad attached to on a turn table, the polishing head comprising:
a workpiece-holding board configured to hold a back surface of the workpiece, the workpiece-holding board being flexible and being composed of ceramics;
a sealed space defined on a surface of the workpiece-holding board on an opposite side of a surface on which the workpiece is held; and
a pressure-controlling means configured to control a pressure in the sealed space,
the polishing head being capable of adjusting a shape of the flexible workpiece-holding board into a convex shape or a concave shape by controlling a pressure in the sealed space by the pressure-controlling means.

9. The polishing head according to claim 8, wherein the workpiece-holding board is flexible to such an extent that a ratio of an outer diameter of the workpiece-holding board to a maximum variation of the adjustment into the convex shape or the concave shape (the maximum variation/the outer diameter) is 0.028×10⁻³ to 0.222×10⁻³.

10. The polishing head according to claim 8, wherein an inner diameter of the sealed space is larger than an outer diameter of the workpiece.

11. The polishing head according to claim 9, wherein an inner diameter of the sealed space is larger than an outer diameter of the workpiece.

12. The polishing head according to claim 8, wherein the pressure-controlling means is capable of controlling one or both of pressurization and depressurization of the sealed space.

13. The polishing head according to claim 11, wherein the pressure-controlling means is capable of controlling one or both of pressurization and depressurization of the sealed space.

14. The polishing head according to claim 8, wherein the workpiece-holding board is composed of alumina ceramics or silicon carbide ceramics.

15. The polishing head according to claim 13, wherein the workpiece-holding board is composed of alumina ceramics or silicon carbide ceramics.

16. A polishing apparatus for polishing a front surface of a workpiece, the polishing apparatus comprising: a polishing pad attached on a turn table; a polishing-agent-supply mechanism configured to supply a polishing agent onto the polishing pad; and a polishing head configured to hold the workpiece according to claim 8.

17. A polishing apparatus for polishing a front surface of a workpiece, the polishing apparatus comprising: a polishing pad attached on a turn table; a polishing-agent-supply mechanism configured to supply a polishing agent onto the polishing pad; and a polishing head configured to hold the workpiece according to claim 15.

18. A method for polishing a workpiece by bringing a front surface of the workpiece into sliding contact with a polishing pad attached on a turn table, the method comprising: holding the workpiece with a polishing head according to claim 8; adjusting a shape of the flexible workpiece-holding board by controlling the pressure in the sealed space of the polishing head; and then polishing the workpiece.

19. A method for polishing a workpiece by bringing a front surface of the workpiece into sliding contact with a polishing pad attached on a turn table, the method comprising: holding the workpiece with a polishing head according to claim 17; adjusting a shape of the flexible workpiece-holding board by controlling the pressure in the sealed space of the polishing head; and then polishing the workpiece.
